(19) United States
(12) Patent Application Publication
(10) Pub. No.: US 2026/0065139 A1
(43) Pub. Date: Mar. 5, 2026

(54) MULTIVARIATE TIME-SERIES PREDICTIVE MODEL DEVELOPMENT IN SITUATIONS WITH UNCERTAIN TIMESTAMP OF THE TARGET VARIABLE

(71) Applicant: Saudi Arabian Oil Company, Dhahran (SA)

(72) Inventors: Petr Kadlec, Dhahran (SA); Mohammed Nashit Babber, Khobar (SA); Modhe Almelihi, Al Jubail (SA); Abdulrahman Fuad Althorman, Khobar (SA); Abdulaziz Almass, Dhahran (SA)

(21) Appl. No.: 18/824,481

(22) Filed: Sep. 4, 2024

(51) Int. Cl. G06N 20/00

(52) U.S. Cl. CPC G06N 20/00

(57) ABSTRACT

A computer-implemented method includes improving statistical properties of data by pre-processing independent time series data and dependent variable time series data, where the pre-processing includes: 1) normalizing, as normalized data, the independent time series data using a max-min scalar; 2) applying, to the normalized data and to generate partial least squares (PLS) processed data, a PLS technique; and 3) discretizing, as discretized data, the dependent variable time series data using a Gaussian Naïve Bayes (GNB) technique. A predictive model is trained using the GNB technique for each target variable class. The predictive model is adaptively retrained.

### BACKGROUND

To improve efficiency of controlling petroleum-based industrial processes, developing multi-variate time-series predictive models (or “soft sensors”) has become common practice. Soft sensors are used to predict important process variables that cannot be measured with automated sensors. However, in situations where a timestamp of a target variable is not reliable or unavailable, traditional approaches in developing soft sensors fail because it is not possible to establish a relation between input (independent) variable and a target (dependent) variable.

### SUMMARY

The present disclosure describes multivariate time-series predictive model development in situations with an uncertain timestamp of the target variable.

In an implementation, computer-implemented method, comprises: improving statistical properties of data by pre-processing independent time series data and dependent variable time series data, wherein the pre-processing comprises: normalizing, as normalized data, the independent time series data using a max-min scalar; applying, to the normalized data and to generate partial least squares (PLS) processed data, a PLS technique; and discretizing, as discretized data, the dependent variable time series data using a Gaussian Naïve Bayes (GNB) technique; training a predictive model using the GNB technique for each target variable class; and adaptively retraining the predictive model.

The described subject matter can be implemented using a computer-implemented method; a non-transitory, computer-readable medium storing computer-readable instructions to perform the computer-implemented method; and a computer-implemented system comprising one or more computer memory devices interoperably coupled with one or more computers and having tangible, non-transitory, machine-readable media storing instructions that, when executed by the one or more computers, perform the computer-implemented method/the computer-readable instructions stored on the non-transitory, computer-readable medium.

The subject matter described in this specification can be implemented to realize one or more of the following advantages. First, the described approach permits developing multivariate time-series predictive models in situations with uncertainty (i.e., not reliable or unavailable) in the timestamp of a target (dependent) variable. Uncertainty in the timestamp is mitigated using machine learning techniques based on a statistical analysis of a relation between input (independent) variables and the target variable. A robust statistical relation between statistical properties (distribution) of the input variables and the target variable is established that can be leveraged to predict the target variable. Second, the described approach uses pre-processing and adaptive modelling techniques to further improve predictive performance and real-life applicability. Third, predictions of the described approach are presented in a statistical manner, which provides the most likely predicted value together with a confidence level of the prediction. Receipt of the two values helps to ensure high acceptance by end users (e.g., human or automated computer processes). The additional information is useful for decision making by the end users. Fourth, the described approach can continuously adapt (re-calibrate) the models to maintain statistical relevance in a changing environment. Fifth, the described approach has high-relevance in industrial applications, where developing multi-variate time-series predictive models (or “soft sensors” has become common practice for predicting important process variables that cannot be measured with automated sensors. Sixth, the described approach can be leveraged in petroleum-based industrial processes to provide additional information to users, and to permit improvements in efficiency when controlling the petroleum-based industrial processes.

The details of one or more implementations of the subject matter of this specification are set forth in the Detailed Description, the Claims, and the accompanying drawings. Other features, aspects, and advantages of the subject matter will become apparent to those of ordinary skill in the art from the Detailed Description, the Claims, and the accompanying drawings.

### DESCRIPTION OF DRAWINGS

FIG. 1 is a flowchart illustrating an example of a computer-implemented method for multivariate time-series predictive model development in situations with an uncertain timestamp of the target variable, according to an implementation of the present disclosure.

FIG. 2 is a box diagram illustrating training of a Gaussian Naïve Bayes (GNB) predictive model, according to an implementation of the present disclosure.

FIG. 3 is a box diagram illustrating application of a GNB predictive model, according to an implementation of the present disclosure.

FIG. 4 is a box diagram illustrating the structure of an algorithm 500 for performing the described approach, according to an implementation of the present disclosure.

FIG. 5 is a diagram illustrating the use of adaptive modelling to ensure that a predictive model reflects the latest state of a process, according to an implementation of the present disclosure.

FIG. 6 is a screenshot of a graphical user interface (GUI) display illustrating results of the use of multivariate time-series predictive model development in situations with an uncertain timestamp of the target variable, according to an implementation of the present disclosure.

FIG. 7 is a block diagram illustrating an example of a computer-implemented system used to provide computational functionalities associated with described algorithms, methods, functions, processes, flows, and procedures, according to an implementation of the present disclosure.

FIG. 8 illustrates hydrocarbon production operations that include both one or more field operations and one or more computational operations, which exchange information and control exploration for the production of hydrocarbons, according to an implementation of the present disclosure.

Like reference numbers and designations in the various drawings indicate like elements.

### DETAILED DESCRIPTION

The following detailed description describes multivariate time-series predictive model development in situations with an uncertain timestamp of the target variable and is presented to enable any person skilled in the art to make and use the disclosed subject matter in the context of one or more particular implementations. Various modifications, alterations, and permutations of the disclosed implementations can be made and will be readily apparent to those of ordinary skill in the art, and the general principles defined can be applied to other implementations and applications, without departing from the scope of the present disclosure. In some instances, one or more technical details that are unnecessary to obtain an understanding of the described subject matter and that are within the skill of one of ordinary skill in the art may be omitted so as to not obscure one or more described implementations. The present disclosure is not intended to be limited to the described or illustrated implementations, but to be accorded the widest scope consistent with the described principles and features.

To improve efficiency of controlling petroleum processing-based industrial processes, developing multi-variate time-series predictive models (or “soft sensors”) has become common practice. Soft sensors are used to predict important process variables that cannot be measured with automated sensors. However, in situations where a timestamp of a target variable is uncertain (i.e., not reliable, or unavailable), traditional approaches in developing soft sensors fail because it is not possible to establish a relation between input (independent) variables and a target (dependent) variable.

The described approach permits developing multivariate time-series predictive models in situations with uncertainty in the timestamp of the target variable. Uncertainty in the timestamp is mitigated using machine learning techniques based on a statistical analysis of a relation between the input variables and a target variable. A robust statistical relation between statistical properties (distribution) of the input variables and the target variable is established that can be leveraged to predict the target variable.

The described approach uses pre-processing and adaptive modelling techniques to further improve predictive performance and real-life applicability. The described approach can also continuously adapt (re-calibrate) the models to maintain statistical relevance in a changing environment.

Predictions of the described approach are presented in a statistical manner, which provides a most likely predicted value together with a confidence level of the prediction. Receipt of the two values helps to ensure high acceptance by end users (e.g., human or automated computer processes). The additional information is useful for decision making by the end users. The described approach can be leveraged in petroleum-based industrial processes to provide additional information to users, and to permit improvements in efficiency in controlling the petroleum-based industrial processes.

A machine learning method is described for predicting target data in situations where a timestamp of a target variable is uncertain, which can occur where the target variable has been historically measured or collected manually (e.g., using a laboratory) and a timestamp of the recording is not captured or is not captured accurately. Accordingly, the timestamp cannot be relied upon. This is a common problem in industrial processes, where certain process characteristics cannot be measured with automated sensors and are measured manually.

The robust statistical relation between statistical properties is established using a Naïve Gauss technique. In order to be able be able to use the Gaussian Naïve Bayes (GNB) technique efficiently and reliably, data is pre-processed to establish statistical properties of the data and to prepare for establishing a predictive model using the GNB technique. As previously mentioned, the predictive model is periodically re-evaluated to ensure the model remains accurate for predictive modelling purposes.

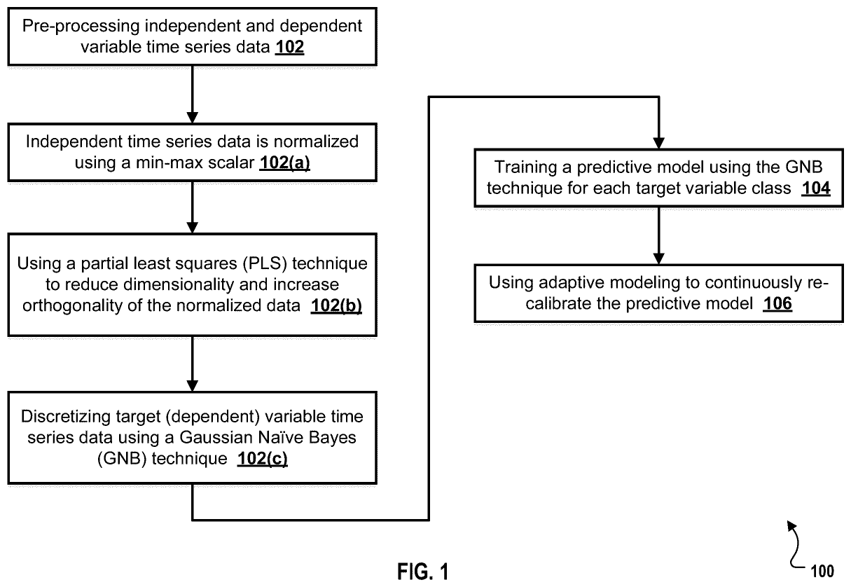

FIG. 1 is a flowchart illustrating an example of a computer-implemented method 100 for multivariate time-series predictive model development in situations with an uncertain timestamp of the target variable, according to an implementation of the present disclosure. For clarity of presentation, the description that follows generally describes method 100 in the context of the other figures in this description. However, it will be understood that method 100 can be performed, for example, by any system, environment, software, and hardware, or a combination of systems, environments, software, and hardware, as appropriate. In some implementations, various steps of method 100 can be run in parallel, in combination, in loops, or in any order.

The described approach can be applied to any application domain developing multivariate time-series predictive models in situations with uncertainty in the timestamp of the target variable. However, method 100 is focused on an industrial petroleum production method. For other application areas, the method steps can be adjusted to accommodate for specific data in the application domain.

At 102, data is pre-processed to improve statistical properties of the data. From 102, method 100 proceeds to 102(a).

At 102(a), independent time series data is normalized using a min-max scaler which maps each input variable to a [0,1] range. This mapping normalizes a scale of the data and avoids over-emphasizing a statistical impact of the data by variables which tend to have naturally high values. From 102(a), method 100 proceeds to 102(b).

At 102(b), a Partial Least Squares (PLS) technique is applied to the normalized data to reduce dimensionality of the normalized data and to increase orthogonality (statistical independence) of the normalized data. The normalized data is normalized to a value range [0 . . . 1]. Statistical independence of data is an assumption used by a GNB technique. From 102(b), method 100 proceeds to 102(c).

At 102(c), the target (dependent) variable time series data is discretized. A GNB technique is applied to the target variable time series data. For example, process chemical (e.g., phosphate) values in the petroleum industry could be discretized to one part per million (1 ppm). Phosphate is used as an anti-corrosive chemical in large number of industrial processes. If the target variable is a continuous variable, the target variable needs to be discretized into a defined number of classes (i.e., distinct values—such as on a scale of 1 to 10, classes could be 1, 2, 3, . . . , 9, and 10). From 102(c), method 100 proceeds to 104.

At 104, a predictive model is trained (built) using the GNB technique for each target variable class. This technique is beneficial in the situation with not reliable or unavailable timestamps, because the technique establishes a predictive model between values of the input (independent) variables and values of the target (dependent) variable in a form of conditional probabilities p(a|b), where a is the value of the target variable estimated based on the value of the input variable b. This conditional relationship avoids using a timestamp for both the input data and the target data. From 104, method 100 proceeds to 106.

At 106, adaptive modelling (retraining) is used to continuously (e.g., in regular intervals—such as, daily) re-calibrate the predictive model to automatically accommodate for a changing environment (data). Changes in the environment are common in industrial methods, where, for example, the method may shift to another method state or data may become unavailable due to sensor issues. After 106, method 100 can stop.

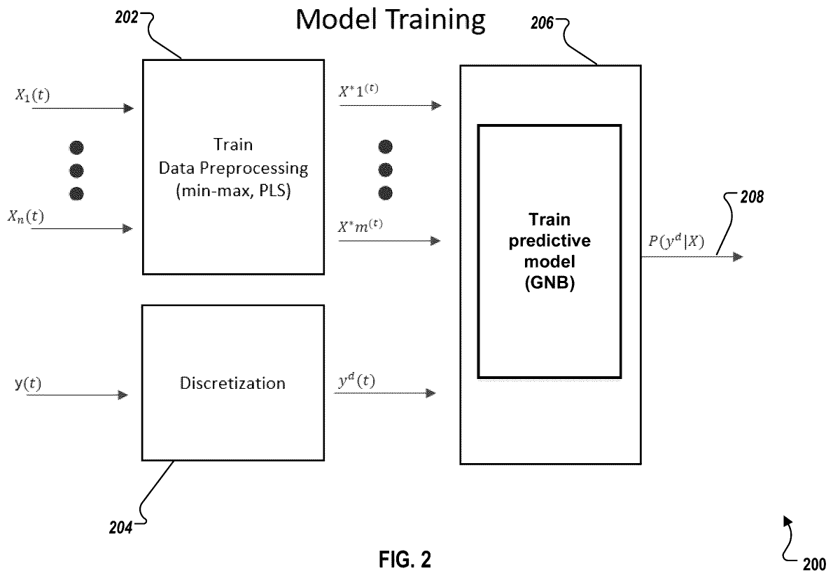

Turning to FIG. 2, FIG. 2 is a box diagram 200 illustrating training of a GNB predictive model, according to an implementation of the present disclosure.

At 202, training data is pre-processed consistent with 102(a)-102(c) of FIG. 1 (i.e., using PLS and min-max). In FIG. 2, xᵢ(t) is the I input (independent) time series data (where, t is time and i has a value of 1 to n), x*ᵢ(t) is pre-processed input times series data reduced from n vectors to m vectors. The PLS technique provides dimensionality reduction (compression) from a vector of n-features to m-features. The predictive model is trained with the provided input x and target variable y.

At 204, y(t) is the target (dependent) variable time series that are discretized. y^{d}(t) is the discretized target variable.

At 206, the predictive model is trained using the GNB technique with xᵢ*(t) and y^{d}(t) are inputs for the predictive model training.

At 208, output P(y^{d}|x) (probability distribution of each class of the output data (y) given the input data (x)) is generated.

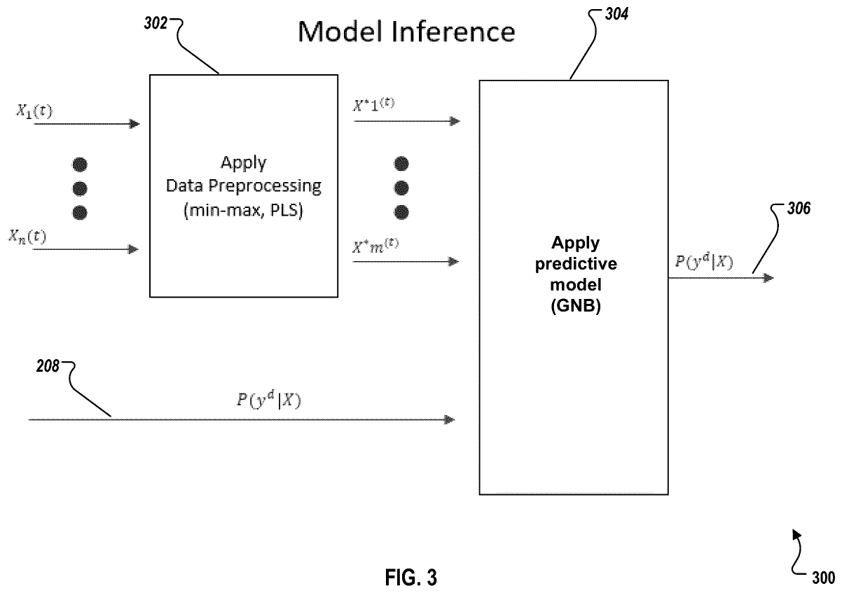

FIG. 3 is a box diagram 300 illustrating application of a GNB predictive model, according to an implementation of the present disclosure.

At 302, data is pre-processed consistent with 102(a)-102(c) of FIG. 1 (i.e., using PLS and min-max). In FIG. 3, xᵢ(t) is the I input (independent) time series data (where, t is time and i has a value of 1 to n), x*ᵢ(t) is pre-processed input times series data reduced from n vectors to m vectors. The predictive model receives input x and produces a prediction of target y.

At 208 P(y^{d}|x) is generated from training a GNB predictive model as in FIG. 2.

At 304, the trained GNB predictive model is applied with xᵢ*(t) and P(y^{d}|x) as inputs for the GNB predictive model.

At 306, output P(y^{d}) is generated, where P(y^{d}) is the probability of y^{d} that is used to infer a most likely prediction of the target (dependent) variable.

In some implementations, provided predictions of residual process chemical concentration can be used by plant engineering to optimally control injection of the process chemical by keeping the concentration within a required process chemical limit. This permitted control not only helps to optimize process performance, but also helps to reduce consumption of the process chemical. In some implementations, the permitted control can be performed by an automated, computer-implemented process.

In some implementations, a computer-implemented controller can be used with inputs and/or outputs of the described approach (e.g., as described in FIGS. 1-3) to automatically or dynamically control physical equipment. For example, a computer-implemented controller could control injectors, process chemical storage tanks, or other equipment necessary to manage injection of a process chemical and maintaining a required process chemical limit.

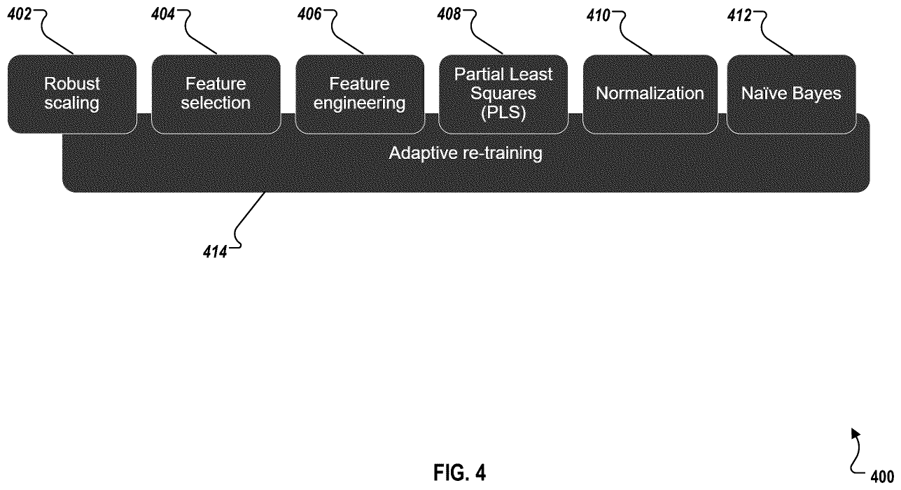

FIG. 4 is a box diagram 400 illustrating the structure of an algorithm 400 for performing the described approach, according to an implementation of the present disclosure. The structure of the algorithm includes robust scaling 402, feature selection 404, feature engineering 406, PLS technique 408, normalization 410, and GNB technique 412.

402 identifies robust scaling as described in 102(a) of FIG. 1, that is data is normalized using a min-max scaler which maps each input variable to a [0,1] range. Normalization 410 is a result of the mapping by robust scaling 402 and normalizes a scale of the data and avoids over-emphasizing a statistical impact of the data by variables which tend to have naturally high values.

Feature selection 404 permits selection of what data is to be predicted. For example, if used with an industrial process related to a boiler in a petroleum plant, feature selection could include delayed process chemical locked, final steam temperature (deg F), final steam pressure (psig), and steam drum level.

Feature engineering 406 permits generating derived features from existing data with a goal to increase predictive model performance. For example, feature engineering can include a 0.5 or a 1.0 hour delay.

PLS 408 is a principal component technique (i.e., compressing data dimensionality while aiming to preserve information content of the data). As described in 102(b) of FIG. 1, PLS is applied to the input data to reduce dimensionality of the data and to increase orthogonality (statistical independence) of the data.

GNB 412 is used to establish a robust statistical relationships between statistical properties. In some implementations, other statistical techniques could be used to establish statistical relationships between statistical properties.

As previously described in 106 of FIG. 1, adaptive retraining 414 is used to continuously re-calibrate the predictive model to automatically accommodate for a changing environment. Changes in the environment are common in industrial methods, where, for example, the method may shift to another method state or data may become unavailable due to sensor issues.

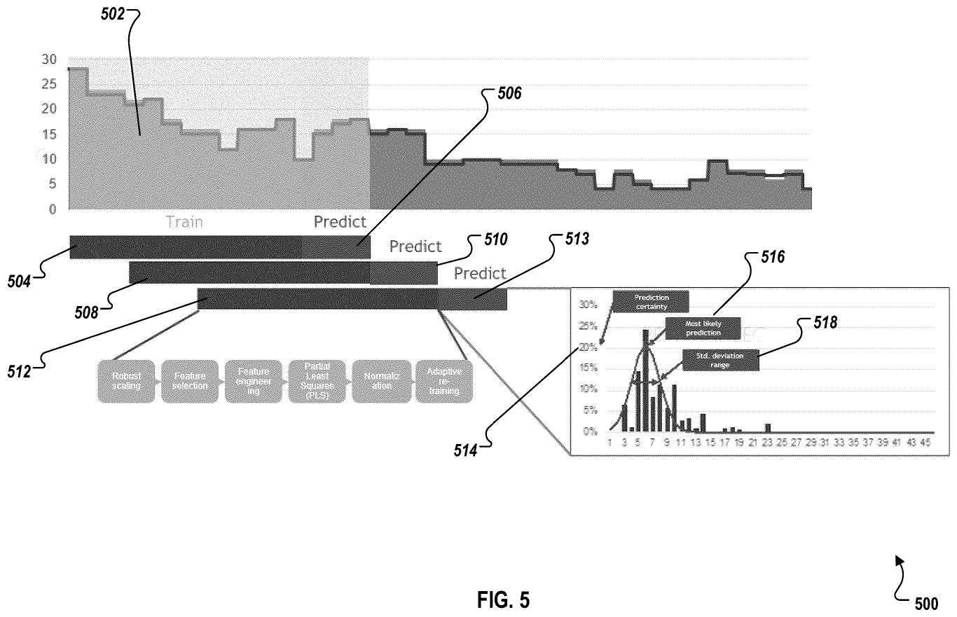

FIG. 5 is a diagram 500 illustrating the use of adaptive modelling to ensure that a predictive model reflects the latest state of a process, according to an implementation of the present disclosure. For a specific data set 502, a predictive model is trained at 504 and a prediction made at 506. The predictive model is retrained at both 508 and 510. In some implementations, retraining can be made on a time-basis. For example, training of the predictive model can be maintained on a rolling timed window (such as, 200 days).

Stated another way, FIG. 5 demonstrates a moving windows adaptive re-training technique, which ensures that the predictive model is always trained on latest data. The area indicated by, e.g., 504, 508, and 512 represents training with known target (dependent) variable values, while the area indicated by, e.g., 506, 510, and 513 represents predicted values. An example prediction shown at 513 includes a predicted certainty 514 (20%), most likely prediction 516 (i.e., the center of a Gaussian bell curve), and a standard deviation range 518. 614 demonstrates a probability distribution P(y\hat{ }d|x) of the predicted target variable classes y\hat{ }d.

In some implementations, some of all of the diagram 500 can be displayed to a user on a graphical user interface (GUI). In some implementations, some portions of the diagram 500 can be selectable/interfaceable to obtain additional information. For example, a user could hover a pointer device over prediction 512 and the graph including 514, 516, and 518 can be generated for display (e.g., such as in a pop-up diagram).

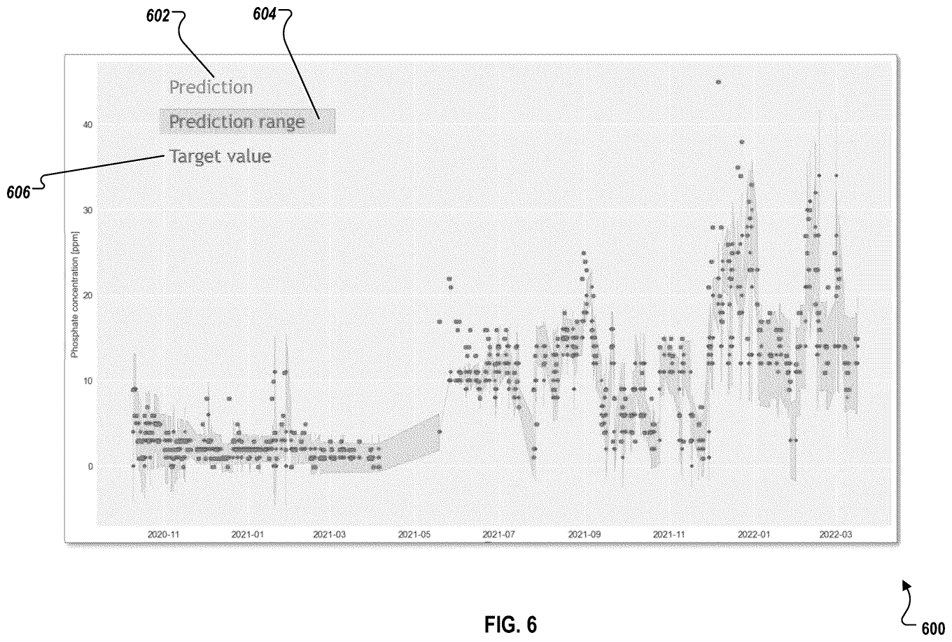

FIG. 6 is a screenshot 600 of a GUI display illustrating results of the use of multivariate time-series predictive model development in situations with an uncertain timestamp of the target variable, according to an implementation of the present disclosure. In FIG. 6, a prediction is indicated by 602, a prediction range (confidence interval) 604, and a target value at 606. As can be seen, the prediction 602 and target value 606 appear to be, on average consistent within the shown prediction range 604.

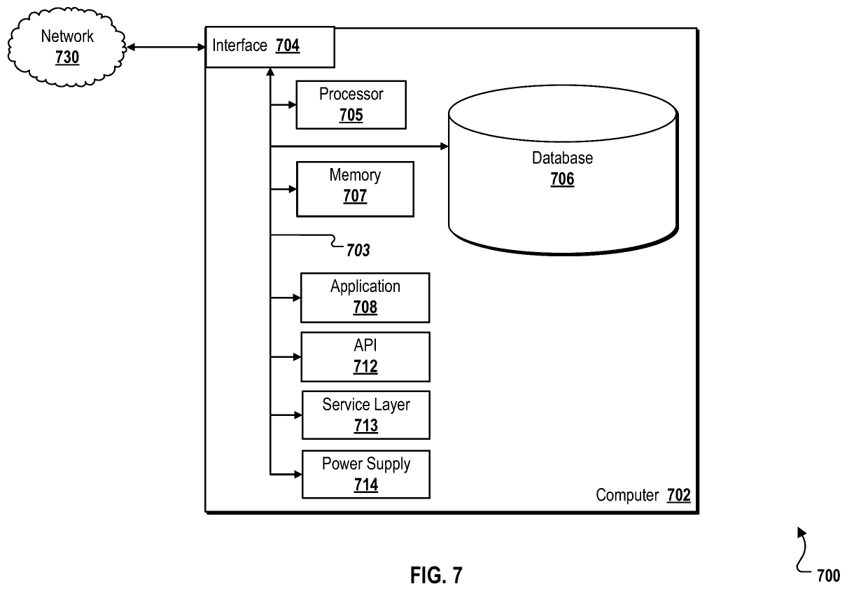

FIG. 7 is a block diagram illustrating an example of a computer-implemented System 700 used to provide computational functionalities associated with described algorithms, methods, functions, processes, flows, and procedures, according to an implementation of the present disclosure. In the illustrated implementation, computer-implemented system 700 includes a Computer 702 and a Network 730.

The illustrated Computer 702 is intended to encompass any computing device, such as a server, desktop computer, laptop/notebook computer, wireless data port, smart phone, personal data assistant (PDA), tablet computer, one or more processors within these devices, or a combination of computing devices, including physical or virtual instances of the computing device, or a combination of physical or virtual instances of the computing device. Additionally, the Computer 702 can include an input device, such as a keypad, keyboard, or touch screen, or a combination of input devices that can accept user information, and an output device that conveys information associated with the operation of the Computer 702, including digital data, visual, audio, another type of information, or a combination of types of information, on a graphical-type user interface (UI) (or GUI) or other UI.

The Computer 702 can serve in a role in a distributed computing system as, for example, a client, network component, a server, or a database or another persistency, or a combination of roles for performing the subject matter described in the present disclosure. The illustrated Computer 702 is communicably coupled with a Network 730. In some implementations, one or more components of the Computer 702 can be configured to operate within an environment, or a combination of environments, including cloud-computing, local, or global.

At a high level, the Computer 702 is an electronic computing device operable to receive, transmit, process, store, or manage data and information associated with the described subject matter. According to some implementations, the Computer 702 can also include or be communicably coupled with a server, such as an application server, e-mail server, web server, caching server, or streaming data server, or a combination of servers.

The Computer 702 can receive requests over Network 730 (for example, from a client software application executing on another Computer 702) and respond to the received requests by processing the received requests using a software application or a combination of software applications. In addition, requests can also be sent to the Computer 702 from internal users (for example, from a command console or by another internal access method), external or third-parties, or other entities, individuals, systems, or computers.

Each of the components of the Computer 702 can communicate using a System Bus 703. In some implementations, any or all of the components of the Computer 702, including hardware, software, or a combination of hardware and software, can interface over the System Bus 703 using an application programming interface (API) 712, a Service Layer 713, or a combination of the API 712 and Service Layer 713. The API 712 can include specifications for routines, data structures, and object classes. The API 712 can be either computer-language independent or dependent and refer to a complete interface, a single function, or even a set of APIs. The Service Layer 713 provides software services to the Computer 702 or other components (whether illustrated or not) that are communicably coupled to the Computer 702. The functionality of the Computer 702 can be accessible for all service consumers using the Service Layer 713. Software services, such as those provided by the Service Layer 713, provide reusable, defined functionalities through a defined interface. For example, the interface can be software written in a computing language (for example JAVA or C++) or a combination of computing languages, and providing data in a particular format (for example, extensible markup language (XML)) or a combination of formats. While illustrated as an integrated component of the Computer 702, alternative implementations can illustrate the API 712 or the Service Layer 713 as stand-alone components in relation to other components of the Computer 702 or other components (whether illustrated or not) that are communicably coupled to the Computer 702. Moreover, any or all parts of the API 712 or the Service Layer 713 can be implemented as a child or a sub-module of another software module, enterprise application, or hardware module without departing from the scope of the present disclosure.

The Computer 702 includes an Interface 704. Although illustrated as a single Interface 704, two or more Interfaces 704 can be used according to particular needs, desires, or particular implementations of the Computer 702. The Interface 704 is used by the Computer 702 for communicating with another computing system (whether illustrated or not) that is communicatively linked to the Network 730 in a distributed environment. Generally, the Interface 704 is operable to communicate with the Network 730 and includes logic encoded in software, hardware, or a combination of software and hardware. More specifically, the Interface 704 can include software supporting one or more communication protocols associated with communications such that the Network 730 or hardware of Interface 704 is operable to communicate physical signals within and outside of the illustrated Computer 702.

The Computer 702 includes a Processor 705. Although illustrated as a single Processor 705, two or more Processors 705 can be used according to particular needs, desires, or particular implementations of the Computer 702. Generally, the Processor 705 executes instructions and manipulates data to perform the operations of the Computer 702 and any algorithms, methods, functions, processes, flows, and procedures as described in the present disclosure.

The Computer 702 also includes a Database 706 that can hold data for the Computer 702, another component communicatively linked to the Network 730 (whether illustrated or not), or a combination of the Computer 702 and another component. For example, Database 706 can be an in-memory or conventional database storing data consistent with the present disclosure. In some implementations, Database 706 can be a combination of two or more different database types (for example, a hybrid in-memory and conventional database) according to particular needs, desires, or particular implementations of the Computer 702 and the described functionality. Although illustrated as a single Database 706, two or more databases of similar or differing types can be used according to particular needs, desires, or particular implementations of the Computer 702 and the described functionality. While Database 706 is illustrated as an integral component of the Computer 702, in alternative implementations, Database 706 can be external to the Computer 702. The Database 706 can hold and operate on at least any data type mentioned or any data type consistent with this disclosure.

The Computer 702 also includes a Memory 707 that can hold data for the Computer 702, another component or components communicatively linked to the Network 730 (whether illustrated or not), or a combination of the Computer 702 and another component. Memory 707 can store any data consistent with the present disclosure. In some implementations, Memory 707 can be a combination of two or more different types of memory (for example, a combination of semiconductor and magnetic storage) according to particular needs, desires, or particular implementations of the Computer 702 and the described functionality. Although illustrated as a single Memory 707, two or more Memories 707 or similar or differing types can be used according to particular needs, desires, or particular implementations of the Computer 702 and the described functionality. While Memory 707 is illustrated as an integral component of the Computer 702, in alternative implementations, Memory 707 can be external to the Computer 702.

The Application 708 is an algorithmic software engine providing functionality according to particular needs, desires, or particular implementations of the Computer 702, particularly with respect to functionality described in the present disclosure. For example, Application 708 can serve as one or more components, modules, or applications. Further, although illustrated as a single Application 708, the Application 708 can be implemented as multiple Applications 708 on the Computer 702. In addition, although illustrated as integral to the Computer 702, in alternative implementations, the Application 708 can be external to the Computer 702.

The Computer 702 can also include a Power Supply 714. The Power Supply 714 can include a rechargeable or non-rechargeable battery that can be configured to be either user-or non-user-replaceable. In some implementations, the Power Supply 714 can include power-conversion or management circuits (including recharging, standby, or another power management functionality). In some implementations, the Power Supply 714 can include a power plug to allow the Computer 702 to be plugged into a wall socket or another power source to, for example, power the Computer 702 or recharge a rechargeable battery.

There can be any number of Computers 702 associated with, or external to, a computer system containing Computer 702, each Computer 702 communicating over Network 730. Further, the term “client,” “user,” or other appropriate terminology can be used interchangeably, as appropriate, without departing from the scope of the present disclosure. Moreover, the present disclosure contemplates that many users can use one Computer 702, or that one user can use multiple computers 702.

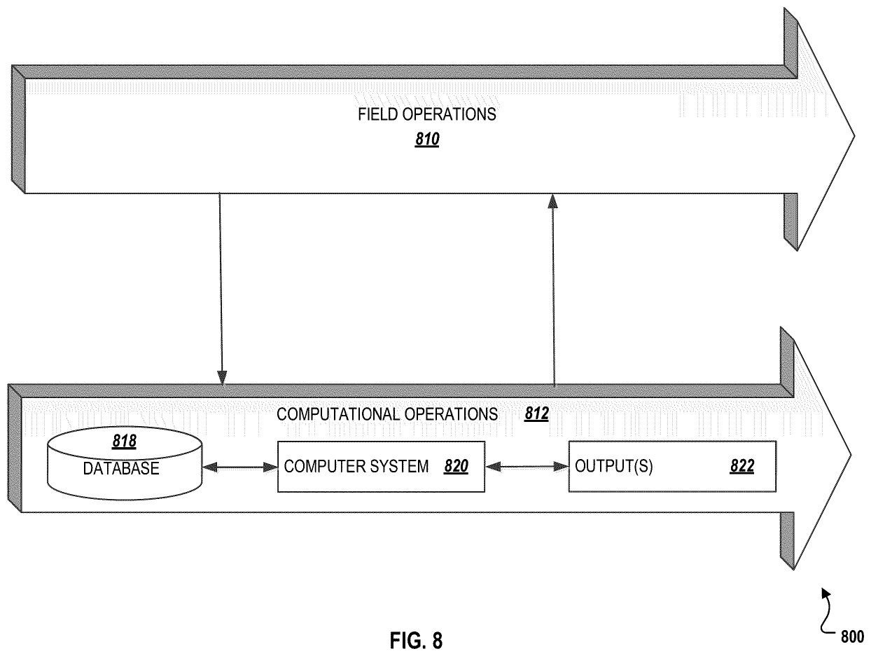

FIG. 8 illustrates hydrocarbon production operations 800 that include both one or more field operations 810 and one or more computational operations 812, which exchange information and control exploration for the production of hydrocarbons. In some implementations, outputs of techniques of the present disclosure can be performed before, during, or in combination with the hydrocarbon production operations 800, specifically, for example, either as field operations 810 or computational operations 812, or both.

Examples of field operations 810 include forming/drilling a wellbore, hydraulic fracturing, producing through the wellbore, injecting fluids (such as water) through the wellbore, to name a few. In some implementations, methods of the present disclosure can trigger or control the field operations 810. For example, the methods of the present disclosure can generate data from hardware/software including sensors and physical data gathering equipment (e.g., seismic sensors, well logging tools, flow meters, and temperature and pressure sensors). The methods of the present disclosure can include transmitting the data from the hardware/software to the field operations 810 and responsively triggering the field operations 810 including, for example, generating plans and signals that provide feedback to and control physical components of the field operations 810. Alternatively, or in addition to, the field operations 810 can trigger the methods of the present disclosure. For example, implementing physical components (including, for example, hardware, such as sensors) deployed in the field operations 810 can generate plans and signals that can be provided as input or feedback (or both) to the methods of the present disclosure.

Examples of computational operations 812 include one or more computer systems 820 that include one or more processors and computer-readable media (e.g., non-transitory computer-readable media) operatively coupled to the one or more processors to execute computer operations to perform the methods of the present disclosure. The computational operations 812 can be implemented using one or more databases 818, which store data received from the field operations 810 and/or generated internally within the computational operations 812 (e.g., by implementing the methods of the present disclosure) or both. For example, the one or more computer systems 820 process inputs from the field operations 810 to assess conditions in the physical world, the outputs of which are stored in the databases 818. For example, seismic sensors of the field operations 810 can be used to perform a seismic survey to map subterranean features, such as facies and faults. In performing a seismic survey, seismic sources (e.g., seismic vibrators or explosions) generate seismic waves that propagate in the earth and seismic receivers (e.g., geophones) measure reflections generated as the seismic waves interact with boundaries between layers of a subsurface formation. The source and received signals are provided to the computational operations 812 where they are stored in the databases 818 and analyzed by the one or more computer systems 820.

In some implementations, one or more outputs 822 generated by the one or more computer systems 820 can be provided as feedback/input to the field operations 810 (either as direct input or stored in the databases 818). The field operations 810 can use the feedback/input to control physical components used to perform the field operations 810 in the real world.

For example, the computational operations 812 can process the seismic data to generate three-dimensional (3D) maps of the subsurface formation. The computational operations 812 can use these 3D maps to provide plans for locating and drilling exploratory wells. In some operations, the exploratory wells are drilled using logging-while-drilling (LWD) techniques which incorporate logging tools into the drill string. LWD techniques can enable the computational operations 812 to process new information about the formation and control the drilling to adjust to the observed conditions in real-time.

The one or more computer systems 820 can update the 3D maps of the subsurface formation as information from one exploration well is received and the computational operations 812 can adjust the location of the next exploration well based on the updated 3D maps. Similarly, the data received from production operations can be used by the computational operations 812 to control components of the production operations. For example, production well and pipeline data can be analyzed to predict slugging in pipelines leading to a refinery and the computational operations 812 can control machine operated valves upstream of the refinery to reduce the likelihood of plant disruptions that run the risk of taking the plant offline.

In some implementations of the computational operations 812, customized user interfaces can present intermediate or final results of the above-described processes to a user. Information can be presented in one or more textual, tabular, or graphical formats, such as through a dashboard. The information can be presented at one or more on-site locations (such as at an oil well or other facility), on the Internet (such as on a webpage), on a mobile application (or app), or at a central processing facility.

The presented information can include feedback, such as changes in parameters or processing inputs, that the user can select to improve a production environment, such as in the exploration, production, and/or testing of petrochemical processes or facilities. For example, the feedback can include parameters that, when selected by the user, can cause a change to, or an improvement in, drilling parameters (including drill bit speed and direction) or overall production of a gas or oil well. The feedback, when implemented by the user, can improve the speed and accuracy of calculations, streamline processes, improve models, and solve problems related to efficiency, performance, safety, reliability, costs, downtime, and the need for human interaction.

In some implementations, the feedback can be implemented in real-time, such as to provide an immediate or near-immediate change in operations or in a model. The term real-time (or similar terms as understood by one of ordinary skill in the art) means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second(s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

Events can include readings or measurements captured by downhole equipment such as sensors, pumps, bottom hole assemblies, or other equipment. The readings or measurements can be analyzed at the surface, such as by using applications that can include modeling applications and machine learning. The analysis can be used to generate changes to settings of downhole equipment, such as drilling equipment. In some implementations, values of parameters or other variables that are determined can be used automatically (such as through using rules) to implement changes in oil or gas well exploration, production/drilling, or testing. For example, outputs of the present disclosure can be used as inputs to other equipment and/or systems at a facility. This can be especially useful for systems or various pieces of equipment that are located several meters or several miles apart, or are located in different countries or other jurisdictions.

Described implementations of the subject matter can include one or more features, alone or in combination.

For example, in a first implementation, a computer-implemented method, comprising: improving statistical properties of data by pre-processing independent time series data and dependent variable time series data, wherein the pre-processing comprises: normalizing, as normalized data, the independent time series data using a max-min scalar; applying, to the normalized data and to generate partial least squares (PLS) processed data, a PLS technique; and discretizing, as discretized data, the dependent variable time series data using a Gaussian Naïve Bayes (GNB) technique; training a predictive model using the GNB technique for each target variable class; and adaptively retraining the predictive model.

The foregoing and other described implementations can each, optionally, include one or more of the following features:

A first feature, combinable with any of the following features, wherein normalizing the data maps each input variable to a [0,1] range.

A second feature, combinable with any of the previous or following features, wherein applying the PLS technique to the normalized data reduces dimensionality and increases orthogonality of the normalized data.

A third feature, combinable with any of the previous or following features, wherein the predictive model is established between values if input (independent) variables and values of a target (dependent) variable in a form of conditional probabilities p(a|b), where a is a value of the target variable estimated based on a value of an input variable b.

A fourth feature, combinable with any of the previous or following features, wherein the predictive model is trained using the GNB technique with the PLS processed data and the discretized data as inputs.

A fifth feature, combinable with any of the previous or following features, wherein output of training the predictive model is P(y^{d}|x), which represents a probability distribution of each class of output data (y) given input data (x).

A sixth feature, combinable with any of the previous or following features, wherein the predictive model is applied using the PLS processed data and P(y^{d}|x) as inputs.

In a second implementation, a non-transitory, computer-readable medium storing one or more instructions executable by a computer system to perform one or more operations, comprising: improving statistical properties of data by pre-processing independent time series data and dependent variable time series data, wherein the pre-processing comprises: normalizing, as normalized data, the independent time series data using a max-min scalar; applying, to the normalized data and to generate partial least squares (PLS) processed data, a PLS technique; and discretizing, as discretized data, the dependent variable time series data using a Gaussian Naïve Bayes (GNB) technique; training a predictive model using the GNB technique for each target variable class; and adaptively retraining the predictive model.

The foregoing and other described implementations can each, optionally, include one or more of the following features:

A first feature, combinable with any of the following features, wherein normalizing the data maps each input variable to a [0,1] range.

A second feature, combinable with any of the previous or following features, wherein applying the PLS technique to the normalized data reduces dimensionality and increases orthogonality of the normalized data.

A third feature, combinable with any of the previous or following features, wherein the predictive model is established between values if input (independent) variables and values of a target (dependent) variable in a form of conditional probabilities p(a|b), where a is a value of the target variable estimated based on a value of an input variable b.

A fourth feature, combinable with any of the previous or following features, wherein the predictive model is trained using the GNB technique with the PLS processed data and the discretized data as inputs.

A fifth feature, combinable with any of the previous or following features, wherein output of training the predictive model is P(y^{d}|x), which represents a probability distribution of each class of output data (y) given input data (x).

A sixth feature, combinable with any of the previous or following features, wherein the predictive model is applied using the PLS processed data and P(y^{d}|x) as inputs.

In a third implementation, a computer-implemented system, comprising: one or more computers; and one or more computer memory devices interoperably coupled with the one or more computers and having tangible, non-transitory, machine-readable media storing one or more instructions that, when executed by the one or more computers, perform one or more operations, comprising: improving statistical properties of data by pre-processing independent time series data and dependent variable time series data, wherein the pre-processing comprises: normalizing, as normalized data, the independent time series data using a max-min scalar; applying, to the normalized data and to generate partial least squares (PLS) processed data, a PLS technique; and discretizing, as discretized data, the dependent variable time series data using a Gaussian Naïve Bayes (GNB) technique; training a predictive model using the GNB technique for each target variable class; and adaptively retraining the predictive model.

The foregoing and other described implementations can each, optionally, include one or more of the following features:

A first feature, combinable with any of the following features, wherein normalizing the data maps each input variable to a [0,1] range.

A second feature, combinable with any of the previous or following features, wherein applying the PLS technique to the normalized data reduces dimensionality and increases orthogonality of the normalized data.

A third feature, combinable with any of the previous or following features, wherein the predictive model is established between values if input (independent) variables and values of a target (dependent) variable in a form of conditional probabilities p(a|b), where a is a value of the target variable estimated based on a value of an input variable b.

A fourth feature, combinable with any of the previous or following features, wherein the predictive model is trained using the GNB technique with the PLS processed data and the discretized data as inputs.

A fifth feature, combinable with any of the previous or following features, wherein output of training the predictive model is P(y^{d}|x), which represents a probability distribution of each class of output data (y) given input data (x).

A sixth feature, combinable with any of the previous or following features, wherein the predictive model is applied using the PLS processed data and P(y^{d}|x) as inputs.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs, that is, one or more modules of computer program instructions encoded on a tangible, non-transitory, computer-readable medium for execution by, or to control the operation of, a computer or computer-implemented system. Alternatively, or additionally, the program instructions can be encoded in/on an artificially generated propagated signal, for example, a machine-generated electrical, optical, or electromagnetic signal that is generated to encode information for transmission to a receiver apparatus for execution by a computer or computer-implemented system. The computer-storage medium can be a machine-readable storage device, a machine-readable storage substrate, a random or serial access memory device, or a combination of computer-storage mediums. Configuring one or more computers means that the one or more computers have installed hardware, firmware, or software (or combinations of hardware, firmware, and software) so that when the software is executed by the one or more computers, particular computing operations are performed. The computer storage medium is not, however, a propagated signal.

The term “real-time,” “real time,” “realtime,” “real (fast) time (RFT),” “near(ly) real-time (NRT),” “quasi real-time,” or similar terms (as understood by one of ordinary skill in the art), means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second(s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

The terms “data processing apparatus,” “computer,” “computing device,” or “electronic computer device” (or an equivalent term as understood by one of ordinary skill in the art) refer to data processing hardware and encompass all kinds of apparatuses, devices, and machines for processing data, including by way of example, a programmable processor, a computer, or multiple processors or computers. The computer can also be, or further include special-purpose logic circuitry, for example, a central processing unit (CPU), a field-programmable gate array (FPGA), or an application-specific integrated circuit (ASIC). In some implementations, the computer or computer-implemented system or special-purpose logic circuitry (or a combination of the computer or computer-implemented system and special-purpose logic circuitry) can be hardware-or software-based (or a combination of both hardware-and software-based). The computer can optionally include code that creates an execution environment for computer programs, for example, code that constitutes processor firmware, a protocol stack, a database management system, an operating system, or a combination of execution environments. The present disclosure contemplates the use of a computer or computer-implemented system with an operating system, for example LINUX, UNIX, WINDOWS, MAC OS, ANDROID, or IOS, or a combination of operating systems.

A computer program, which can also be referred to or described as a program, software, a software application, a unit, a module, a software module, a script, code, or other component can be written in any form of programming language, including compiled or interpreted languages, or declarative or procedural languages, and it can be deployed in any form, including, for example, as a stand-alone program, module, component, or subroutine, for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files, for example, files that store one or more modules, sub-programs, or portions of code. A computer program can be deployed to be executed on one computer or on multiple computers that are located at one site or distributed across multiple sites and interconnected by a communication network.

While portions of the programs illustrated in the various figures can be illustrated as individual components, such as units or modules, that implement described features and functionality using various objects, methods, or other processes, the programs can instead include a number of sub-units, sub-modules, third-party services, components, libraries, and other components, as appropriate. Conversely, the features and functionality of various components can be combined into single components, as appropriate. Thresholds used to make computational determinations can be statically, dynamically, or both statically and dynamically determined.

Described methods, processes, or logic flows represent one or more examples of functionality consistent with the present disclosure and are not intended to limit the disclosure to the described or illustrated implementations, but to be accorded the widest scope consistent with described principles and features. The described methods, processes, or logic flows can be performed by one or more programmable computers executing one or more computer programs to perform functions by operating on input data and generating output data. The methods, processes, or logic flows can also be performed by, and computers can also be implemented as, special-purpose logic circuitry, for example, a CPU, an FPGA, or an ASIC.

Computers for the execution of a computer program can be based on general or special-purpose microprocessors, both, or another type of CPU. Generally, a CPU will receive instructions and data from and write to a memory. The essential elements of a computer are a CPU, for performing or executing instructions, and one or more memory devices for storing instructions and data. Generally, a computer will also include, or be operatively coupled to, receive data from or transfer data to, or both, one or more mass storage devices for storing data, for example, magnetic, magneto-optical disks, or optical disks. However, a computer need not have such devices. Moreover, a computer can be embedded in another device, for example, a mobile telephone, a personal digital assistant (PDA), a mobile audio or video player, a game console, a global positioning system (GPS) receiver, or a portable memory storage device, for example, a universal serial bus (USB) flash drive, to name just a few.

Non-transitory computer-readable media for storing computer program instructions and data can include all forms of permanent/non-permanent or volatile/non-volatile memory, media and memory devices, including by way of example semiconductor memory devices, for example, random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices; magnetic devices, for example, tape, cartridges, cassettes, internal/removable disks; magneto-optical disks; and optical memory devices, for example, digital versatile/video disc (DVD), compact disc (CD)-ROM, DVD+/-R, DVD-RAM, DVD-ROM, high-definition/density (HD)-DVD, and BLU-RAY/BLU-RAY DISC (BD), and other optical memory technologies. The memory can store various objects or data, including caches, classes, frameworks, applications, modules, backup data, jobs, web pages, web page templates, data structures, database tables, repositories storing dynamic information, or other appropriate information including any parameters, variables, algorithms, instructions, rules, constraints, or references. Additionally, the memory can include other appropriate data, such as logs, policies, security or access data, or reporting files. The processor and the memory can be supplemented by, or incorporated in, special-purpose logic circuitry.

To provide for interaction with a user, implementations of the subject matter described in this specification can be implemented on a computer having a display device, for example, a cathode ray tube (CRT), liquid crystal display (LCD), light emitting diode (LED), or plasma monitor, for displaying information to the user and a keyboard and a pointing device, for example, a mouse, trackball, or trackpad by which the user can provide input to the computer. Input can also be provided to the computer using a touchscreen, such as a tablet computer surface with pressure sensitivity or a multi-touch screen using capacitive or electric sensing. Other types of devices can be used to interact with the user. For example, feedback provided to the user can be any form of sensory feedback (such as, visual, auditory, tactile, or a combination of feedback types). Input from the user can be received in any form, including acoustic, speech, or tactile input. In addition, a computer can interact with the user by sending documents to and receiving documents from a client computing device that is used by the user (for example, by sending web pages to a web browser on a user's mobile computing device in response to requests received from the web browser).

The term “graphical user interface (GUI) can be used in the singular or the plural to describe one or more graphical user interfaces and each of the displays of a particular graphical user interface. Therefore, a GUI can represent any graphical user interface, including but not limited to, a web browser, a touch screen, or a command line interface (CLI) that processes information and efficiently presents the information results to the user. In general, a GUI can include a number of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back-end component, for example, as a data server, or that includes a middleware component, for example, an application server, or that includes a front-end component, for example, a client computer having a graphical user interface or a Web browser through which a user can interact with an implementation of the subject matter described in this specification, or any combination of one or more such back-end, middleware, or front-end components. The components of the system can be interconnected by any form or medium of wireline or wireless digital data communication (or a combination of data communication), for example, a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11x or other protocols, all or a portion of the Internet, another communication network, or a combination of communication networks. The communication network can communicate with, for example, Internet Protocol (IP) packets, frame relay frames, Asynchronous Transfer Mode (ATM) cells, voice, video, data, or other information between network nodes.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any inventive concept or on the scope of what can be claimed, but rather as descriptions of features that can be specific to particular implementations of particular inventive concepts. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features can be described as acting in certain combinations and even initially claimed as such, one or more features from a claimed combination can, in some cases, be excised from the combination, and the claimed combination can be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations can be considered optional), to achieve desirable results. In certain circumstances, multitasking or parallel processing (or a combination of multitasking and parallel processing) can be advantageous and performed as deemed appropriate.

The separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

What is claimed is:

1. A computer-implemented method, comprising:
improving statistical properties of data by pre-processing independent time series data and dependent variable time series data, wherein the pre-processing comprises:
normalizing, as normalized data, the independent time series data using a max-min scalar;
applying, to the normalized data and to generate partial least squares (PLS) processed data, a PLS technique; and
discretizing, as discretized data, the dependent variable time series data using a Gaussian Naïve Bayes (GNB) technique;
training a predictive model using the GNB technique for each target variable class; and
adaptively retraining the predictive model.

2. The computer-implemented method of claim 1, wherein normalizing the data maps each input variable to a [0,1] range.

3. The computer-implemented method of claim 1, wherein applying the PLS technique to the normalized data reduces dimensionality and increases orthogonality of the normalized data.

4. The computer-implemented method of claim 1, wherein the predictive model is established between values if input (independent) variables and values of a target (dependent) variable in a form of conditional probabilities p(a|b), where a is a value of the target variable estimated based on a value of an input variable b.

5. The computer-implemented method of claim 1, wherein the predictive model is trained using the GNB technique with the PLS processed data and the discretized data as inputs.

6. The computer-implemented method of claim 5, wherein output of training the predictive model is P(y^{d}|x), which represents a probability distribution of each class of output data (y) given input data (x).

7. The computer-implemented method of claim 6, wherein the predictive model is applied using the PLS processed data and P(y^{d}|x) as inputs.

8. A non-transitory, computer-readable medium storing one or more instructions executable by a computer system to perform one or more operations, comprising:
improving statistical properties of data by pre-processing independent time series data and dependent variable time series data, wherein the pre-processing comprises:
normalizing, as normalized data, the independent time series data using a max-min scalar;
applying, to the normalized data and to generate partial least squares (PLS) processed data, a PLS technique; and
discretizing, as discretized data, the dependent variable time series data using a Gaussian Naïve Bayes (GNB) technique;
training a predictive model using the GNB technique for each target variable class; and
adaptively retraining the predictive model.

9. The non-transitory, computer-readable medium of claim 8, wherein normalizing the data maps each input variable to a [0,1] range.

10. The non-transitory, computer-readable medium of claim 8, wherein applying the PLS technique to the normalized data reduces dimensionality and increases orthogonality of the normalized data.

11. The non-transitory, computer-readable medium of claim 8, wherein the predictive model is established between values if input (independent) variables and values of a target (dependent) variable in a form of conditional probabilities p(a|b), where a is a value of the target variable estimated based on a value of an input variable b.

12. The non-transitory, computer-readable medium of claim 8, wherein the predictive model is trained using the GNB technique with the PLS processed data and the discretized data as inputs.

13. The non-transitory, computer-readable medium of claim 12, wherein output of training the predictive model is P(y^{d}|x), which represents a probability distribution of each class of output data (y) given input data (x).

14. The non-transitory, computer-readable medium of claim 13, wherein the predictive model is applied using the PLS processed data and P(y^{d}|x) as inputs.

15. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations, comprising:
improving statistical properties of data by pre-processing independent time series data and dependent variable time series data, wherein the pre-processing comprises:
normalizing, as normalized data, the independent time series data using a max-min scalar;
applying, to the normalized data and to generate partial least squares (PLS) processed data, a PLS technique; and
discretizing, as discretized data, the dependent variable time series data using a Gaussian Naïve Bayes (GNB) technique;
training a predictive model using the GNB technique for each target variable class; and
adaptively retraining the predictive model.

16. The computer-implemented system of claim 15, wherein normalizing the data maps each input variable to a [0,1] range.

17. The computer-implemented system of claim 15, wherein applying the PLS technique to the normalized data reduces dimensionality and increases orthogonality of the normalized data.

18. The computer-implemented system of claim 15, wherein the predictive model is established between values if input (independent) variables and values of a target (dependent) variable in a form of conditional probabilities p(a|b), where a is a value of the target variable estimated based on a value of an input variable b.

19. The computer-implemented system of claim 15, wherein the predictive model is trained using the GNB technique with the PLS processed data and the discretized data as inputs.

20. The computer-implemented system of claim 19, wherein output of training the predictive model is P(y^{d}|x), which represents a probability distribution of each class of output data (y) given input data (x).
